(19) United States
(12) Patent Application Publication
(10) Pub. No.: US 2019/0147536 A1
(43) Pub. Date: May 16, 2019

(54) ASSURED INITIAL MARGIN RETURN AMOUNT (AIMRA) SYSTEM

(71) Applicant: FS Innovation LLC, Westport, CT (US)

(72) Inventors: Stephen Frank, Ridgewood, NJ (US); David Szmukler, Westport, CT (US)

(73) Assignee: FS Innovation LLC, Westport, CT (US)

(21) Appl. No.: 15/809,426

(22) Filed: Nov. 10, 2017

(51) Int. Cl. G06Q 40/06; G06Q 40/04; G06Q 40/02; H04L 29/06

(52) U.S. Cl. CPC G06Q 40/06; H04L 63/0428; G06Q 40/025; G06Q 40/04

(57) ABSTRACT

Systems, methods and techniques described herein, provide an assured initial margin return amount system (an “AIMRA system”) for receiving and processing derivative transaction data from first and second parties to a derivative transaction and investor requirements data from one or more investors. The AIMRA system can process the data to generate an assured initial margin return amount, a first IM funding amount for the first party and a second IM funding amount for the second party. The assured initial margin return amount can be used to extract value from posted initial margin while the initial margin is being held in segregated custodial accounts. The AIMRA system can generate senior note(s) and junior note(s) having different security values. A total value of the senior note(s) and the junior note(s) corresponds to the total value of the first IM funding amount and the second IM funding amount.

### BACKGROUND

As is known in the art, derivative transaction systems, such as those described in U.S. Pat. No. 8,583,533, can perform various services to enable parties to the derivative transaction to setup and ultimately complete the transaction. In recent years various global regulators have promulgated new margin rules for derivative transactions commonly referred to as uncleared swaps. The new rules require two-way collecting and/or posting of “initial margin” between certain financial entities when they enter into derivative trades to which the new margin rules apply (for purposes of this application all derivative transactions, all parties to such derivative transactions and all initial margin discussed herein refer to derivative transactions, parties to derivative transactions and initial margin covered by the new margin rules, as amended from time to time). Stated differently, when two parties such as Party A and Party B enter into uncleared swap transaction(s) with each other, both Party A and Party B are required to simultaneously post and/or collect initial margin (“IM”) to and from, as applicable, each other. In each case, the posted IM is required to be held in a segregated account with a third party custodian. The final rules further require that the custodial agreements for holding IM prohibit the custodian and any party to the derivative transaction from rehypothecating, repledging, reusing or otherwise transferring any funds or property posted as initial margin.

While existing derivative transaction systems are in place to handle such transactions, the new margin rules result in a store of excess collateral held in segregated custodial accounts.

### SUMMARY

In accordance with the concepts, systems, methods and techniques described herein, an assured initial margin return amount system is created to calculate, determine, create and generate an assured initial margin return amount, which can be used to extract value from posted initial margin, and to process and store derivative transaction data, collateral data, derivative counterparty funding needs and investor funding requirements (hereinafter such assured initial margin return amount system referred to as an “AIMRA System”). In addition, the AIMRA system can monitor initial margin collateral to certify that any collateral or other requirements for funding or other transactions in which the assured initial margin return amounts is utilized are being met. The AIMRA system can be coupled to two or more parties to the derivative transaction to receive and process data for a particular derivative transaction or a portfolio of derivative transactions as well as one or more parties to receive and process information on collateral posted to third party custodians. The objective of the AIMRA system is to calculate, determine, create and generate an assured initial margin return amount, which can be used to extract value from posted initial margin and determine a collateral package from the initial margin being posted by the parties to the derivative portfolio, whereby the collateral package will serve as security against notes or other contracts and thus be used to reduce investor's credit risk, increase investor's risk adjusted yield, reduce collateral posters' funding costs or improve other balance sheet metrics such as leverage ratio. In one embodiment, the collateral package, including the assured initial margin return amount, generated by the AIMRA system can secure loans made by a lender to two parties who post initial margin to each other.

In another embodiment, the collateral package, including the assured initial margin return amount, generated by the AIMRA System can secure one or more senior notes and/or one or more junior notes, having different security levels. The senior notes and junior notes can be fully secured or partially secured based at least in part on the collateral package determined by the AIMRA system. In this way the collateral package can be used to reduce the risk level for potential investors and lenders who provide funding to the parties to the derivative transaction or a portfolio of derivative transactions. Among other things, the reduced risk-levels should allow parties to the derivative transaction(s) to fund themselves at more favorable rates which reflect the reduced risk-level to the funders. This new and reduced cost of funds should allow those parties to price derivatives more competitively.

The AIMRA system can calculate, determine, create and generate an assured initial margin return amount, which can be used to extract value from posted initial margin, and, in some embodiments, generate various types of loans and/or notes having different security levels (e.g., different levels of security, guarantees, recoveries and returns) to raise funds for the parties to the derivative transaction which funds can then be used by such parties, to, among other things, finance and post their respective initial margin.

A portfolio database can be established, for example, by the AIMRA system, to store the derivatives data, the initial margin data and any specific requirements and constraints imposed by the derivatives parties and/or investors. The AIMRA system can control functionality of the portfolio database and encrypt and store data for a particular derivative transaction or portfolio in the portfolio database. The portfolio database can include segregated accounts to separately store data for each party to the derivative transaction and include a combined account to combine and/or compare data received from the parties to the derivative transaction. The data may include the relevant derivative portfolios between the parties involved, initial margin data for the particular derivative transaction(s) and portfolio(s), and other funding related data generated by the AIMRA system for the particular derivative transaction(s) and portfolio(s).

As stated above, each party to the relevant derivative portfolio is required to post and/or collect initial margin in respect of the derivative portfolio. The initial margin is an amount of eligible collateral that represents, at minimum, the potential future fluctuations of the derivative portfolio and, under certain current rules, can be calculated based on the 99% 10-day potential move in the derivative portfolio mark-to-market against the respective party. Parties to the relevant derivatives portfolio can require additional initial margin to be posted.

The initial margin represents excess margin (overcollateralization) above and beyond what would be needed to cover the then-current swap exposure. Thus, in light of the requirement that both parties simultaneously collect and/or post initial margin for the same set of transaction(s), the AIMRA system can determine a guaranteed amount of initial margin the return of which at least one of the parties will be entitled to, and assured of, upon termination or default of the derivatives portfolio in any and all cases (i.e., in any and all default, termination and voluntary unwind scenarios). The requirement that both parties collect and/or post initial margin and that the posted initial margin be held with a third party custodian (different from the AIMRA system) without the possibility of rehypothecation, repledge, reuse or other transfer by the third party, means that, in cases of a default or termination of the derivatives portfolio to which the IM relates, even those cases where both parties are defaulting parties, one or more parties to the derivative transaction will be entitled to receive a return of the initial margin it has posted and which is being held by a custodian.

The AIMRA system enables swap parties and investors to utilize, and benefit from, the fact that at least one party to the derivative transaction(s) can be assured that the entire value of the initial margin they posted will be available to be returned to said party upon termination or default of the transaction; the amount assured to be available to be returned under the applicable AIMRA system is referred to herein as an “Assured IM Return Amount” and is determined, created and generated by the AIMRA system using the data received from the parties to the derivative transaction(s), their third party custodians, and the investors, lenders or other funders.

The Assured IM Return Amount can be used to extract value in various ways. Loans can be made to each derivative party secured by the return of initial margin (if any) to that party. In some embodiments, one or more classes of notes for investors can be used to fund those loans, with different classes of notes having different security levels tied to the assets securing those loans. A security level of a particular note can be based at least in part on the Assured IM Return Amount generated by the AIMRA system.

Notes issued (probably by a legal entity specially created for this purpose, such entity being referred to herein as a “Special Purpose Vehicle” or an “SPY”) can include senior notes and junior notes and the funds received via the note issuance can be used to fund, among other things, the loans to the swap parties for the purposes of, among other things, posting initial margin. For example, in one embodiment, if one party to a derivative transaction posts an initial margin of $10 and the other party to that derivative transaction posts an initial margin of $12, then the AIMRA system may determine that at the time of a termination or default, should one occur, there will be at least $10 (here the lower amount posted) available to be returned to one of the two parties to the derivative transaction (i.e., the AIMRA system may determine that an Assured IM Return Amount of $10 exists). If there are no additional constraints, loans of $10 can be provided to each of the derivative parties secured by the return of the initial margin they respectively posted. In turn, those two $10 loans can be funded through the issuance of two $10 notes to investors, with one of those $10 notes effectively fully secured by the Assured IM Return Amount of $10. In one embodiment, such notes can be issued by an SPV.

Loans to the swap parties can be funded by creating different classes of notes for investors, with each class being provided a different security level. The security level applicable to a note may impact the return rate to be paid to noteholders of a note, possibly in an inverse manner where the higher the security level applicable to a note the lower the return rate to be paid to noteholders and vice versa. For example, in some embodiments, senior notes issued by an SPV can have a first security level (and a return rate reflecting that first security level) and junior notes issued by the SPV can have a second, different security level (and a return rate reflecting that second security level). In one embodiment, the senior notes can be fully secured (e.g., 100% backed by the Assured IM Return Amount) and the junior notes can be unsecured or partially secured. The number of investor classes, the security levels, and the return rates can vary, based at least in part on the particular types of assets which make up the initial margin.

The AIMRA system can determine an IM Funding Amount (e.g., the size of the loan) for each party to the derivative transaction. The IM Funding Amount can be approximately equal to or a percentage of the initial margin the respective party is required to post for the derivative transaction(s) or portfolio(s). However, the IM Funding Amount for each party may be materially lower than the initial margin posted by the respective party due to investment limitations by the investors, collateral available to be posted by the derivative party and/or collateral requirements by the investor.

Prior to the date on which the derivatives portfolio is unwound, the party to the derivative transaction(s) which will be entitled to the return of the initial margin (the Assured IM Return Amount) is unknown (i.e., the party to the derivative transaction(s) which will be entitled to the return of the initial margin cannot be determined with certainty prior to the date on which the derivatives portfolio is unwound). For example, without our AIMRA system, even if a creditor/investor to a party to the derivatives transaction(s) were to take a subordinated security interest in posted IM in order to secure a loan, the creditor/investor will not be assured that the IM will be available upon a termination event or default to secure the loan since the IM may first be applied to any obligations owed on the derivatives. However, even with this uncertainty, the AIMRA system we have created can determine a guaranteed return of IM (i.e. an Assured IM Return Amount) to a portion of the investors, with collateral which meets or exceeds the investor requirements, if any. The AIMRA system can have determined an Assured IM Return Amount which, in one embodiment, can serve as collateral to loans and/or be allocated to those investors who invest in the notes issued by an SPV which provided those secured loans.

The AIMRA system can help extract the trapped value of the initial margin posted during a derivative transaction. In some embodiments, methods are described herein to provide for an Assured IM Return Amount that is a predetermined percentage of the IM funding amounts provided to the parties to the derivative transaction. In other embodiments, the Assured IM Return Amount is determined by analyzing data and collateral requirements from both the derivative parties (and/or their third party custodians) as well as the investors. In all cases the Assured IM Return Amount is used to secure funding or other contracts (e.g., guarantees, facilities, other derivatives, etc.) in order to reduce investor's credit risk, increase investor's risk adjusted yield, reduce derivative parties' funding costs or obtain other balance sheet or economic benefits for the derivative parties, investors and/or other funders.

In a first aspect, a method includes transmitting derivative transaction data from a first party to an assured initial margin return amount (AIMRA) system for a derivative transaction and transmitting derivative transaction data from a second party to the AIMRA system for the derivative transaction. The AIMRA system is coupled to the first and second parties through an encrypted connection. The method further includes transmitting investor requirements data from one or more investors to the AIMRA system, processing the derivative transaction data received from the first and second parties and the investor requirements data from the one or more investors to generate an assured IM return amount, processing the derivative transaction data and the assured IM return amount and the investor requirements data from the one or more investors to determine a first IM funding amount for the first party and a second IM funding amount for the second party, storing the derivative transaction data, investor requirements data, assured IM return amount, first IM funding amount and the second IM funding amount in a portfolio database communicatively coupled to the AIMRA system, and processing the derivative transaction data, investor requirements data, assured IM return amount, first IM funding amount and the second IM funding amount to generate one or more senior notes and one or more junior notes having different security values. In an embodiment, a total value of the one or more senior notes and the one or more junior notes corresponds to the total value of the first IM funding amount and the second IM funding amount.

The derivative transaction data can include at least one or more of derivative data, derivative portfolio data, initial margin data, funding requirements data and initial margin collateral parameters.

The method may further include receiving a first loan from a special purpose vehicle to fund the first IM funding amount and a second loan from the special purpose vehicle to fund the second IM funding amount. In some embodiments, the special purpose vehicle can issue the senior notes and junior notes. An encrypted connection can be established between the AIMRA system and the first and second parties, the one or more investors, or one or more third party custodians.

In some embodiments, the derivative transaction data, investor requirements data, assured IM return amount, first IM funding amount and the second IM funding amount can be encrypted in the portfolio database. The special purpose vehicle can issue a first counterparty loan to the first party through the encrypted connection and a second counterparty loan to the second party through the encrypted connection.

The method may further include assigning, by the AIMRA system, security values for the one or more senior notes and the one or more junior notes, wherein the one or more senior notes have a security value at a first level and the one or more junior notes have a security value at a second, different level. The total amount of senior notes can be equal to a predetermined percentage of the first IM funding amount and the second IM funding amount. The total amount of the junior notes can be equal to a predetermined percentage of the first IM funding amount and the second IM funding amount.

The AIMRA system can receive segregated custodial account data for the first and second parties and storing the segregated custodial account data in the portfolio database.

The senior notes can be fully secured and the junior notes can be partially secured. The AIMRA system can be remotely located from the first and second parties.

In another aspect, a system includes an assured initial margin return amount system (AIMRA) system, a portfolio database communicatively coupled to the AIMRA system, a first party coupled to the AIMRA system through a first secure connection, and a second party coupled to the AIMRA system through a second secure connection. The first and second parties transmit derivative transaction data for a derivative transaction to the AIMRA system. The AIMRA system is configured to process the derivative transaction data from the first and second parties to generate an assured IM return amount, a first IM funding amount for the first party, a second IM funding amount for the second party, store the derivative transaction data, the assured IM return amount, the first IM funding amount, the second IM funding amount in the portfolio database, and process the derivative transaction data, the assured IM return amount, the first IM funding amount, the second IM funding amount to generate one or more senior notes and one or more junior notes having different security values. A total value of the one or more senior notes and the one or more junior notes corresponds to the total value of the first IM funding amount and the second IM funding amount.

The first and second secure connections can form a secure network between the AIMRA system and the first and second parties. The AIMRA system can be configured to encrypt the derivative transaction data, the assured IM return amount, the first IM funding amount, the second IM funding amount, the one or more senior notes, and the one or more junior notes in the portfolio database.

The AIMRA system can be configured to process the derivative transaction data, the assured IM return amount, the first IM funding amount, the second IM funding amount to generate a first counterparty loan for the first party and generate a second counterparty loan for the second party. The AIMRA system can be communicatively coupled to segregated custodial accounts for the first and second parties and stores segregated custodial account data for the first and second parties in the portfolio database. In some embodiments, the AIMRA system can be remotely located from the first and second parties.

In another aspect, a method for securing and collateralizing funding between multiple parties based on initial margin values of the parties is provided. The method includes determining and generating, by an assured initial margin return amount system (AIMRA) System, an assured IM return amount, determining, by the AIMRA system, a first IM funding amount for a first party to the derivative transaction, determining, by the AIMRA system, a second IM funding amount for a second party to the derivative transaction, generating, by the AIMRA system, first and second counterparty loans for the first and second parties, respectively, wherein the first and second counterparty loans are a predetermined percentage of the first and second IM funding amounts, and establishing, by the AIMRA system, one or more senior notes and one or more junior notes having different security values. A total value of the one or more senior notes and the one or more junior notes corresponds to the total value of first and second IM funding amounts. The method further includes securing and collateralizing, by the AIMRA system, the first and second counterparty loans to the first and second parties, respectively through initial margin posted by the first and second parties, respectively, for the derivative transaction.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

The foregoing features may be more fully understood from the following description of the drawings in which like reference numerals indicate like elements:

FIG. 1 shows a block diagram of a derivative transaction between two parties and coupled to an AIMRA system through a secure network;

FIG. 1A illustrates the components of the elements of the derivative transaction of FIG. 1,

FIG. 2 shows a block diagram of an AIMRA processor of the AIMRA system of FIG. 1;

FIG. 2A shows a block diagram of a memory component of the AIMRA system of FIG. 1;

FIG. 3 is a block diagram illustrating an exchange of initial margins and derivative portfolios for a derivative transaction by the two parties of FIG. 1;

FIG. 4 is a block diagram illustrating an SPV providing a secured loan to each of the two parties of the derivative transaction of FIG. 1;

FIG. 5 is a block diagram illustrating an SPV issuing senior and junior notes to fund the secured loans of FIG. 4;

FIG. 6 is a block diagram illustrating the relationship between the AIMRA system of FIG. 0.1 and one or more investors to the derivative transaction between the two parties of FIG. 1;

FIGS. 7-7B are a flow diagram of a method for establishing the Assured IM Return Amounts in conjunction with the derivative transaction of FIG. 1; and

FIG. 8 is a block diagram showing a hardware architecture of the AIMRA system of FIG. 1.

### DETAILED DESCRIPTION

As stated above, parties to a portfolio of derivative transactions (e.g., one or more uncleared swaps) are required to collect and/or post initial margin (IM) to be held in a segregated account by an independent third party custodian for the duration of the derivative transactions. The initial margin reduces each party's counterparty exposure and the amount of initial margin represents the estimated potential future fluctuation of the derivative portfolio to which such IM relates. Under certain current regulations the initial margin calculation is, at minimum, based on the 99% 10-day potential move in the derivative portfolio mark-to-market against the respective party to the derivative transaction.

The AIMRA systems as described herein can calculate, determine, create and generate an Assured IM Return Amount. The Assured IM Return Amount is a calculated amount of initial margin which can serve as a security package to, among other things, reduce the cost of funding of the initial margin to be posted or otherwise mitigate key metrics for the initial margin poster (i.e., leverage ratio) and/or its investors or funders. For example, in one embodiment, the initial margin to be posted by the parties to the derivative transaction can be funded through the issuance of one or more loans secured by the return of initial margin. In one embodiment, these secured loans are funded through use of an SPV and the issuance by the SPV of one or more notes, each note possibly having different priority rights to the Assured IM Return Amount and/or other rights of the SPV. In another embodiment, a single party provides the two loans directly to the derivative counterparties.

The two parties, party A and party B, to a derivative portfolio are required to simultaneously post and/or collect initial margin to and from, as applicable, each other and, in each case, the posted initial margin is required to be held in segregated custodial accounts by an independent third party. All of the initial margin posted by at least one of the parties will be available to be returned in the case of a default, termination or voluntary unwind scenario. In some embodiments, the lower of the two amounts of IM posted is assured of being available to be returned and can be the maximum Assured IM Return Amount. Thus, in some embodiments, the AIMRA system can determine a range for the size of secured loans for party A and party B based on the maximum Assured IM Return Amounts which, in turn, is based at least in part on the initial margin posted by the two parties to the derivative transaction. Other parameters and inputs received by the AIMRA system will affect the range of Assured IM Return Amount.

The AIMRA system can receive and process derivative portfolio data and initial margin data from both party A and party B (and/or their third party custodians) to determine the maximum Assured IM Return Amount for the derivative transaction(s) in the portfolio (e.g., at any point in time, the lesser of the initial margins posted or to be posted by either party A or party B). The AIMRA system can also receive other data from party A and party B (and/or their third party custodians) such as desired amount of funding (or possibly a minimum and maximum amount of desired funding), parameters of collateral (e.g., initial margin collateral parameters) available to be posted, etc. To receive the data, the AIMRA system can establish a secure communications network with parties A and B (and/or their third party custodians).

The AIMRA system can generate the Assured IM Return Amount and the characteristics of the necessary collateral requirements (e.g., asset classes, obligors, tenors, currencies, etc.) based on the maximum Assured IM Return Amount and inputs from both parties to the derivative portfolio as well as the party or parties which will be providing monies or assets to the derivative counterparties, directly or indirectly. In some embodiments, the initial margin collateral parameters may include at least one of or a combination of asset classes, obligors, tenors, and/or currencies.

In some embodiments, two classes of investors, senior investors and junior investors, can fund the initial margins for party A and party B via an SPV. Senior investors may receive senior notes that are fully secured by the Assured IM Return Amount. Junior investors may be offered junior notes that are unsecured or secured by other initial margin (if any) that may or not may not be returned. Thus, a senior investor can invest in fully secured notes (e.g., 100% backed) that are secured by the Assured IM Return Amount determined by the AIMRA system. In other embodiments, investor(s) post the assets necessary to meet party A's and party B's initial margin requirements and receive performance guarantees from party A and party B in respect of the return of that posted collateral. Investors which contribute the assets can divide up the priority to receipt of the Assured IM Return Amount in whatever manner suits their risk tolerance and return requirements. In some embodiments there may be multiple levels or layers of funders or intermediary funders (i.e., funders who fund other funders who then ultimately fund the parties to the derivatives or ultimately fund the initial margin).

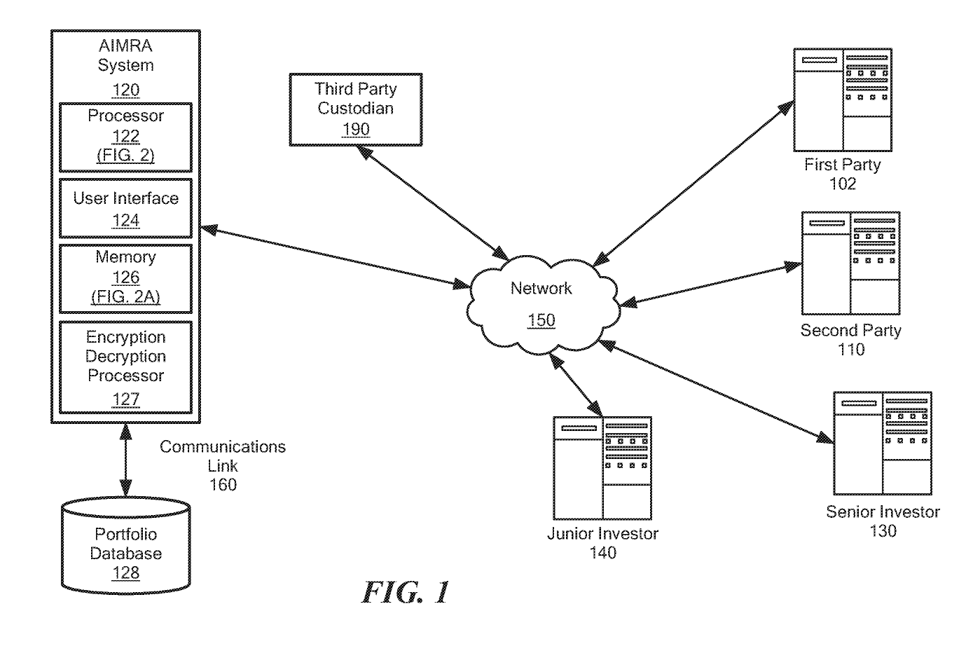

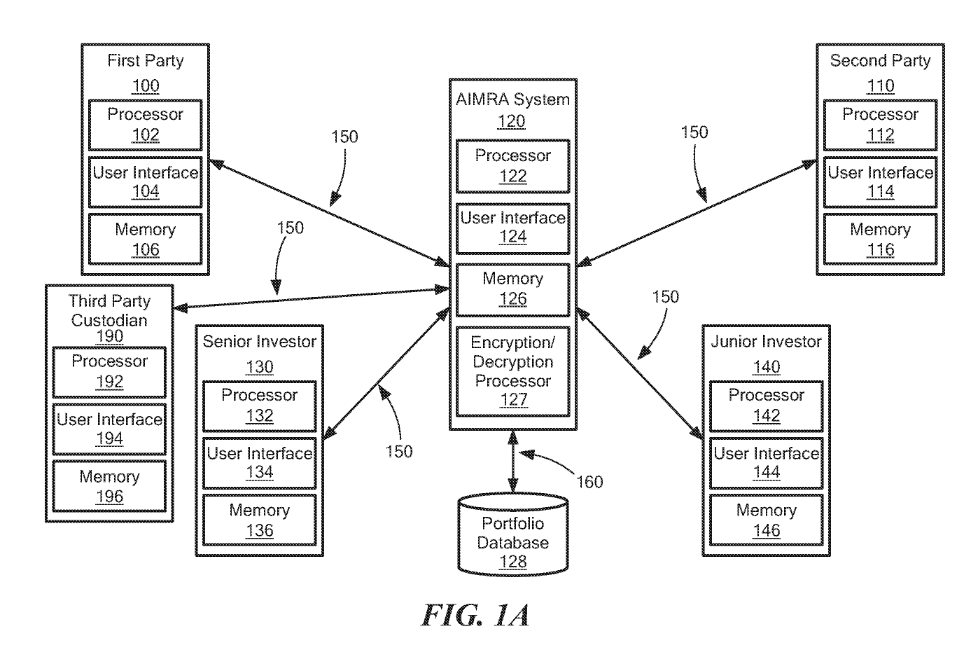

Now referring to FIGS. 1-1A, in which like reference numerals indicate like elements, an AIMRA system 120 is communicatively coupled to a first party 102 and a second party 110 through network 150. In an embodiment, the first and second parties 102, 110 can be different entities involved in a derivative transaction 100, as described herein. Network 150 can be a secure network established by AIMRA system 120 to securely communicate data with each of first and second parties 102, 110.

The information received by the AIMRA system 120 can be used to calculate, determine, create and generate the Assured IM Return Amount. In some embodiments, funding or other solutions may be effectuated through a special purpose vehicle (SPV) or similar entity and may include providing secured loans to the derivative counterparties and issuing secured notes to one or more investors or third parties posting collateral on behalf of the derivative counterparties. The AIMRA system 120 can be used to receive and process initial margin data from each party involved in the particular derivative transaction or derivatives portfolio, here first and second parties 102,110, and generate the Assured IM Return Amount and the collateral package which will serve as security for loans, notes or other contracts. The AIMRA system 120 can also receive initial margin collateral data from one of many parties including the derivative counterparties 102, 110 or third parties such as custodians. The AIMRA system 120 can monitor collateral assets posted to meet initial margin requirements to determine if the collateral parameters as agreed amongst the derivative counterparties and the relevant investors are being met at all times.

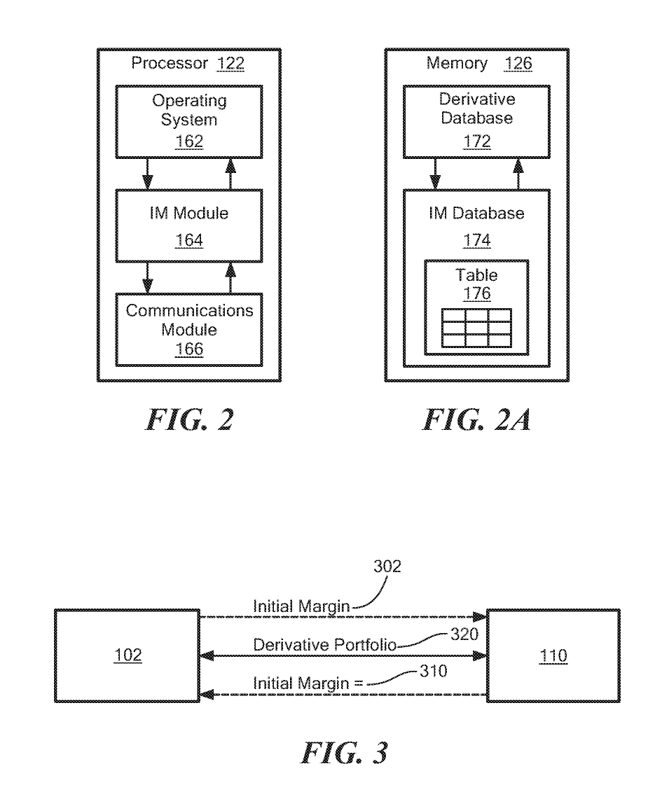

AIMRA system 120 includes an AIMRA processor 122, user interface 124, memory 126 and an encryption/decryption processor 127, each of which may be communicatively coupled with each other within AIMRA system 120. AIMRA processor 122 can be configured to receive and process a variety of different types of data including but not limited to initial margin data, derivative data as well as parameters such as desired funding amounts (or range of desired funding amounts), desired investment amounts (or range of desired investment amounts) and initial margin collateral characteristics (i.e., available or acceptable asset classes, ratings, tenors, currencies and possibly risk metrics or other restrictions). AIMRA processor 122 can also be configured to receive and process a variety of different types of data including but not limited to data in respect of the collateral posted as initial margin by both parties to a derivative portfolio. AIMRA processor will be described in greater detail with respect to FIG. 2.

User interface 124 may include a graphical user interface (GUI) (e.g., a display or touchscreen, etc.). In an embodiment, user interface 124 provides an interface for a user or administrator to enter, modify or provide information and data for the derivative transaction 100.

Memory 126 and encryption/decryption processor 127 will be described in greater detail with respect to FIG. 2.

First party 102 includes a first party processor 103, user interface 104, and a memory 106. Second party 110 includes a second party processor 112, user interface 114, and a memory 116. First and second party processors 103, 112 can be configured to control operation of first and second parties 102, 110 respectively and each of their respective components (i.e., user interfaces 104, 114, memory 106, 116). Memory 106 can be configured to store derivative portfolio data and initial margin data for first party 102. Memory 116 can be configured to store derivative portfolio data and initial margin data for second party 110.

It should be appreciated that although FIG. 1A illustrates two parties in the derivative transaction 100, in other embodiments, derivative transaction 100 may include derivative transactions between multiple pairs of parties trading derivatives (that is to say more than two parties may use the same AIMRA system or, if the parties prefer, separate AIMRA systems could be used for each pair of parties trading derivatives). The design of the AIMRA system may accommodate multiple trading pairs or, if the participants prefer, single trading pairs and, in either case, generate Assured IM Return Amounts and other information which can be used in conjunction with the issuance of a variety of different types of loans and notes to raise funds for the parties to the derivative transaction 100, some of which can be backed by the Assured IM Return Amount. The AIMRA system can also check that collateral posted to satisfy initial margin requirements satisfies any requirements agreed in respect of the Assured IM Return Amount.

As illustrated in FIG. 1, AIMRA system 120 may be communicatively coupled to a senior investor 130 and a junior investor 140. Although, FIG. 1 illustrates two types of investors in the notes, here senior investor 130 and junior investor 140, in other embodiments, the notes (or other form of investment) may have one class of investor or multiple classes of investors, including, among other things, investors whose notes (or other form of investment) vary by the type of IM, if any, or level of priority by which they are backed by the Assured IM Return Amount and/or other funds received.

Senior investor 130 includes a senior processor 132, user interface 134, and a memory 136. Senior processor 132 can be configured to control operation of senior investor 130 and each of its respective components (i.e., user interface 134, memory 136). Memory 136 can be configured to store investment amounts and requirements, derivative portfolio data, initial margin data and other initial margin characteristics, risk metric constraints or additional haircuts and restrictions on collateral to be posted to meet initial margin requirements.

Junior investor 140 includes a junior processor 142, user interface 144, and a memory 146. Junior processor 142 can be configured to control operation of junior investor 140 and each of its respective components (i.e., user interface 144, memory 146). Memory 146 can be configured to store investment amounts and requirements, derivative portfolio data, initial margin data and other initial margin characteristics, risk metric constraints or additional haircuts and restrictions on collateral to be posted to meet initial margin requirements.

AIMRA system 120 can be coupled to a portfolio database 128 through a communications link 160. For example, AIMRA system 120 may be remotely located from portfolio database 128 and may be communicatively coupled to portfolio database 128 through communications link 160. Communications link 160 may include, but not be limited to, various network links, wireless connections, direct (e.g., hard-wired) connections and be configured for communicating data (e.g., initial margin data, financial data, security data) between AIMRA system 120 and portfolio database 128. In some embodiments, portfolio database 128 may be a component of AIMRA system 120.

In some embodiments, portfolio database 128 may be a component of AIMRA system 120.

Network 150 and/or communications link 160 may be provided as a secure network having one or more encrypted connections between any combination of the first party 102, second party 110, AIMRA system 120, one or more investors (in this embodiment, senior investor 130, junior investor 140), portfolio database 128, and/or third party custodian 190. The network 150 and/or communications link 160 can include one or more sub-networks and/or one or more individual connections, and can be installed between any combination of the first party 102, second party 110, AIMRA system 120, senior investor 130, junior investor 140 and portfolio database 128, and/or third party custodian 190

In some embodiments, the network 150 and/or communications link 160 can be provided as: a local-area network (LAN); a metropolitan area network (MAN); a wide area network (WAN); a primary private (or secure) network comprised of multiple sub-networks between the first party 102, second party 110, AIMRA system 120, senior investor 130, junior investor 140, portfolio database 128 and/or third party custodian 190. Still further embodiments include a network 150 and/or a communications link 160 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; or a wireline network.

Now referring to FIG. 2-2A, embodiments of the AIMRA processor 122 and memory 126 of the AIMRA system 120 of FIG. 1 are provided.

For example, and as illustrated in FIG. 2, AIMRA processor 122 includes an operating system 162, an IM module 164, and a communications module 166. AIMRA processor 122 can be configured to control operation of AIMRA system 120 and each of its components (i.e., user interface 124, memory 126, encryption/decryption processor 127). For example, AIMRA processor 122 can be configured to execute computer instructions to process various types of data, encrypt data and/or decrypt data.

IM module 164 can include a calculations processor and/or a trade processor to process initial margin data, determine the Assured IM Return Amount, determine IM Funding Amounts for one or more parties to the derivative transaction 100 and/or determine one or more types of notes (e.g., senior notes, junior notes) to raise funds for the parties to the derivative transaction; which funds can be used, to, among other things, fund their respective initial margin amounts. For example, in some embodiments, IM module 164 can retrieve initial margin data (including amounts and collateral characteristics) from portfolio database 128 and calculate, among other things, the Assured IM Return Amount and/or IM Funding Amounts for one or more parties to the derivative transaction 100.

Communications module 166 can be configured establish communication for AIMRA system 120 within network 150. For example, communications module 166 can be configured to connect with, retrieve and transmit data with first and second parties 102, 110, senior investor 130, junior investor 140, third party custodians 190 and/or portfolio database 128.

As illustrated in FIG. 2A, memory 126 includes a derivative database 172 and IM database 174. Derivative database 172 and IM database 174 can be configured to store data, electronic information, electronic files, images, documents, text files, tables, lists, or any other form of electronic data that includes information. For example, derivative database 172 can be accessed by AIMRA system 120 and be used to store derivative profiles and derivative market data (e.g., 10-day potential move data, market volatility data) for parties to the derivative transaction 100. IM database 174 can be accessed by AIMRA system 120 and be used to store initial margin data, initial margin funding amounts and any other form of data used to determine initial margins, determine Assured IM Return Amounts and determine funding amounts for initial margins for parties to the derivative transaction 100.

Derivative database 172 and IM database 174 can each include separate or otherwise segregated accounts for each party to the derivative transaction 100 (i.e., first party 102, second party 110).

In some embodiments, derivative database 172 and IM database 174 can each include tables, database, or other forms of storage repositories to store and/or organize the various types of data. For example, and as illustrated in FIG. 2, initial margin database 174 may include a table 176. Table 176 may include one or more sub-tables to store initial margin data for one or more parties to a derivative transaction and/or compare initial margin data for the one or more parties to the derivative transaction. In one embodiment, table 176 may be formed having a plurality of rows and columns to systematically display and organize initial margin data. It should be appreciated that derivative database 172 may include one or more tables that are the same as or substantially similar to table 176 of IM database 174.

Memory 126 may include computer storage media, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by AIMRA system 120.

Encryption/decryption module 127 can be configured to encrypt and/or decrypt data to be stored in memory 126. For example, encryption/decryption module 127 can encrypt data prior to storing the data in derivative database 172 and/or IM database 174. Further, encryption/decryption module 127 can decrypt data retrieved from derivative database 172 and/or IM database 174. Encryption/decryption module 127 can be configured to utilize a variety of different encryption and/or decryption techniques and/or algorithms to secure data for a particular derivative transaction.

Now referring to FIG. 3, a block diagram illustrating initial margin and data transfer between two parties, here first party 102 and second party 110 to a derivative transaction is provided. First and second parties 102, 110 can enter into a series of derivative transactions (i.e., derivative portfolio). The transactions which the parties and investors collectively determine can be relevant to the AIMRA system (e.g., AIMRA system 120 of FIGS. 1-1A) and the determination of the Assured IM Return Amount can make up the derivative portfolio covered by the AIMRA system. In some embodiments the derivative portfolio covered by the AIMRA system may consist of more than one derivative portfolio. In some embodiments the derivative portfolio covered by the AIMRA System may consist of (i) just one derivative transaction, (ii) multiple derivative transactions, (iii) a particular portfolio of derivatives transactions or (iv) multiple derivatives portfolios. In some embodiments the derivatives portfolio may consist of a combination of individual transactions and derivatives portfolios. The grouping of transactions or derivatives portfolios which make up a particular derivatives portfolio will be determined by the AIMRA System based on the preferences and determinations of the parties and the investors.

As stated above, margin rules for a derivative transaction or derivative portfolio, such as uncleared swaps, require a two-way transfer (e.g., collecting and/or posting by each party) of initial margins between certain financial entities. Thus, and as illustrated in FIG. 3, first party 102 posts a first initial margin 302 at a first amount and second party 110 posts a second initial margin 310 at a second amount. It should be appreciated that the initial margins 302, 310 are posted to and held by one or more third parties 190 independent of the first and second parties 102, 110.

In some embodiments, the initial margins 302, 310 posted by the parties to the derivative transaction may be the same. In other embodiments, the initial margins 302, 310 posted by the parties to the derivative transaction may be different. The initial margins 302, 310 reduce counterparty exposure while the derivative transactions are outstanding and represent the potential future fluctuation of the relevant derivative portfolio mark-to-market. The amount of the initial margins 302, 310 posted by each party should (under certain current regulations) be determined based at least in part on a 99% 10-day potential move in the derivative portfolio mark-to-market against the respective party.

The initial margin collateral parameters can, in some embodiments, meet or otherwise correspond to the eligibility criteria set forth in the new margin regulations (as amended from time to time). Thus, the initial margin can be high quality liquid assets, with mandated haircuts (i.e. discounts applied based on the various characteristics of the posted collateral e.g., obligor, asset type, tenor, rating, etc.) that are applied to its market value. Parties to the derivative transactions can agree on further restrictions on the initial margin collateral. Additionally, investors or other parties which may fund or contribute collateral can place even further restrictions on the initial margin collateral or subset thereof (such further restrictions may include, but are not limited to, larger haircuts, concentration limits, restrictions on obligors, asset types, tenor, ratings, etc.).

As indicated above, the initial margins must be placed with third party custodians and no party to the transaction (including the first and second parties 102, 110 and/or the third party holding the initial margins) can rehypothecate, repledge, reuse or otherwise transfer the collateral posted as initial margin. Thus, the initial margin is effectively stranded at the third party custodian with no additional extraction of value possible (re-hypothecation, etc.). Further, the initial margin posted by at least one party will never be utilized to cover payment amounts owed to the other party (since, at any given point in time, only one of the two parties to the particular derivative transaction or derivatives portfolio will be out-of-the-money; thus at any given point in time the initial margin posted by at least one of the parties (for example, the in-the-money-party) will be available to be returned to that party should the derivatives terminate or default). As a result, when both parties to one or more derivative transaction(s) simultaneously hold margin from the other party in respect of the same transaction(s), that can create significant material costs and inefficiencies for the counterparties, here first and second parties 102, 110, to the portfolio of derivative transactions (i.e. there is a duplicative and redundant excess amount of IM being held at all times that will never be used). The AIMRA system 120 as described herein can be configured to mitigate and/or otherwise lessen some of these material costs and inefficiencies.

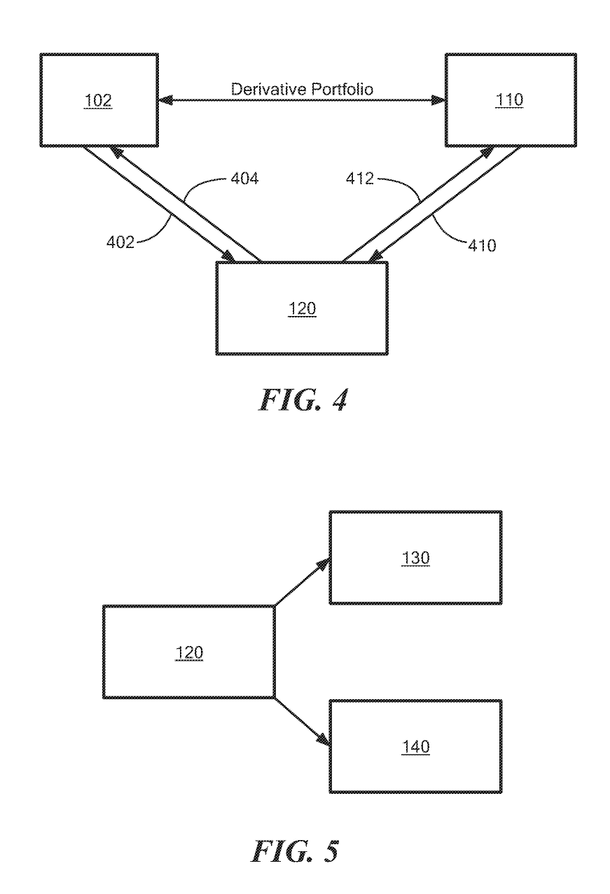

Now referring to FIG. 4, AIMRA system 120 is communicatively coupled to first and second parties 102, 110 through secure network 150. In an embodiment, calculations by the AIMRA system 120 can be used to determine the amount of notes (as well as security and other characteristics) to be issued by a special purpose vehicle (i.e. SPV) which, in turn, provides said funds or collateral to the first and second parties 102, 110 or, in certain cases, their third party custodians, including for purposes of posting their respective initial margins.

AIMRA system 120 can receive first initial margin data 402 and derivative portfolio data from first party 102 (and its third party custodian 190) and receive second initial margin data 410 and derivative portfolio data from second party 110 (and its third party custodian 190). AIMRA system 120 can encrypt and store first and second initial margin data 402, 410 and/or portfolio data in portfolio database 128. In some embodiments, AIMRA system 120 creates segregated accounts in portfolio database 128 to store data from each of first and second parties 102, 110 and their respective custodians. AIMRA system 120 can further create one or more combined accounts to compare data received from each of first and second parties 102, 110 and their respective custodians.

First and second initial margin data 402, 410 (along with information regarding first and second parties funding needs and/or data from third party custodians and investors) can be used to determine, among other things, an Assured IM Return Amount. The Assured IM Return Amount can be a predetermined percentage of the initial margin to be posted by first party 102, second party 110 or a predetermined percentage of the total value of the initial margins to be posted by both first and second parties 102, 110. The Assured IM Return Amount can then be used to determine IM Funding Amounts and loan and note characteristics, including which loan and subsequently notes can be secured by the Assured IM Return Amount. For example, in some embodiments, the IM Funding Amount can be a loan to first party 102 and/or second party 110 that first party 102 and/or second party 110 can use to purchase and post their respective initial margin for the derivative transaction or portfolio. Thus, the IM Funding Amount should be equal to or less than the initial margin to be posted by first party 102 and/or second party 110. In some embodiments, AIMRA System 120 can generate different IM Funding Amounts for first and second parties 102, 110.

In one embodiment, AIMRA system 120 can be used to determine the number and amount of notes (as well as security and other characteristics) to be issued by a special purpose vehicle which, in turn, can generate and provide a first secured loan 404 to first party 102 and a second secured loan 412 to second party 110 (i.e., the funds raised by the SPV's note issuance can be used to fund the secured loans). The first and second secured loans 404, 412 can be approximately equal to the IM Funding Amount for first party 102 and/or second party 110. In some embodiments, the first and second secured loans 404, 412 can be the same amount. In other embodiments, the first and second secured loans 404, 412 can be different amounts. The first and second secured loans 404, 412 may also be referred to herein as first and second counterparty loans or more generally counterparty loans.

The first and second secured loans 404, 412 can be documented under a loan agreement or issued as a note or similar security. It should be appreciated that first and second parties 102, 110 secure their respective individual loans by granting a subordinated interest in the IM or in any return amount of the IM (subordinated to any application of such IM in connection with the derivative portfolio in respect of which such IM was posted). Depending on the desires of the relevant parties, in some embodiments, there is no cross-collateralization of each other's loan obligations while in other embodiments there can be cross-collateralization of each other's loan obligations (i.e. in other words in some embodiments the grant of a subordinated interest in the IM or in any return amount of the IM made by first party 102 and second party 110 to secure the respective loans they each received will also secure (i.e. cross-collateralize) the loan received by the other party).

First and second parties 102, 110 can provide different forms of collateral for first and second secured loans 404, 412, respectively. However, the first and second party can provide sufficient amounts of eligible collateral to meet the requirements of the investors or others as outlined in the relevant investor documentation (e.g., note offering documentation if investments are made via notes issued by an SPV) or in other contractual documentation.

How much, if any, of the initial margin each of the parties may receive upon close-out of the derivative transaction is dependent on, among other things, market movement, liquidity and/or volatility between the dealer default and the close-out of the derivative portfolio. For example, upon default of either first party 102 or second party 110 or both first and second parties 102, 110, a close-out of the derivative portfolio occurs and first party 102 or second party 110 may be owed a net settlement from the other party, referred to herein as the close-out amount, that is based on the close-out values of the derivative portfolio and the last variation margin posted. In no case do both parties 102 and 110 owe a close-out amount (i.e. an amount based on the close-out values of the derivatives and the last variation margin posted) in respect of a particular derivative portfolio or a particular derivative transaction as at any given point in time only one party, 102 or 110, can owe a close-out amount to the other in the case of a particular derivative portfolio or a particular derivative transaction between those two parties.

With respect to IM posted in respect of a particular derivative portfolio or a particular derivative transaction, in all cases at least one party, 102 or 110, will not owe a close-out amount to the other party and therefore be entitled to a return of all the IM it has posted. In some cases, even the party, 102 or 110, that owes a close-out amount to the other party can be entitled to a return of all or some of the IM it has posted in respect of a particular derivative portfolio or a particular derivative transaction based on the solvency of the party which owes the close-out amount and the close-out amount versus the amount of initial margin posted. In other words, with respect to any given derivative transaction or portfolio of derivative(s), in some cases both parties will be entitled to a return of IM and in some cases one party will not be entitled to a return of IM, but in all cases at least one party will be entitled to a return of all the IM it has posted. To put it another way since, in respect of a particular derivative portfolio or a particular derivative transaction at any given time, only one party can owe a close-out amount, if any, to the other party then with respect to IM upon termination or default:

(i) one party, 102 or 110, will be entitled to a return of all the IM it has posted and the other party, 102 or 110, will be entitled to a return of all of the IM it has posted;

(ii) one party, 102 or 110, will be entitled to a return of all the IM it has posted and the other party, 102 or 110, will be entitled to a return of some of the IM it has posted; or

(iii) one party, 102 or 110, will be entitled to a return of all the IM it has posted and the other party, 102 or 110, will not be entitled to a return of IM it has posted.

In each case of termination, default or voluntary unwind at least one party, 102 or 110, is entitled to a return of all the IM it has posted. That said, upon any termination, default or voluntary unwind even the party that owes the close-out amount (i.e. the party that is out-of-the-money) will, if the close-out amount is less than the amount of IM it has posted, receive, on a net basis, a return of the initial margin it has posted minus the close-out amount they owe. The party that is owed the close-out amount (i.e. the party that is in-the-money) will receive a return of the initial margin it has posted plus be entitled to the close-out amount they are owed. Thus, first and second secured loans 404, 412 can be used to back notes issued by an SPV having an aggregate guaranteed return percentage or amount based at least in part on initial margin assured of being returned (i.e. based on the Assured IM Return Amount calculated, determined, created and generated by AIMRA System 120).

Now referring to FIG. 5, AIMRA system 120 can determine classes of notes (e.g., senior and junior notes) for investors, here an investor in senior notes 130 and an investor in junior notes 140, to be issued by an SPV to raise funds so that the first and second secured loans 404, 412 can be provided to first and second parties 102, 110. It should be appreciated that although FIG. 5 shows two classes of investors, in other embodiments, AIMRA system 120 may determine one class of investors or more than two classes of investors is possible.

The different investor classes can receive notes generated by AIMRA system 120 and having different security levels. For example, the senior investors 130 can receive senior notes having a first security level that are fully secured (e.g., 100% backed) by the assured initial margin return amount and/or a percentage of the assured initial margin return amount due to the first and second parties 102, 110 upon a termination or default of the derivative transaction(s). Stated differently, the senior notes can be fully secured by the initial margin posted by first party 102 or second party 110, independent of default by first party 102, second party 110 or both first and second parties 102, 110. To put it another way, with the Assured IM Return Amount calculated, determined, created and generated by AIMRA system 120, the senior notes can be fully secured if there is a default by first party 102, if there is a default by second party 110 or even if there is a default by both first and second parties 102, 110.

The junior investors 140 can receive junior notes having a second security level (different from the first level) that are not secured or are partially secured (e.g., less than 100% backed) by the returned initial margin amount and/or a percentage of an IM return amount due to the first and second parties 102, 110 upon a termination or default of the derivative transaction. Stated differently, junior notes can have unsecured exposure to the defaulting party (for example, if the defaulting party is also the out-of-the-money party). That said, to the extent the close-out amount, if any, owed by the defaulting party is less than the initial margin posted by the defaulting party, the junior note can be at least partially secured by initial margin minus the close-out amount owed by the defaulting party, if any (in some cases the defaulting party may owe nothing or even be the in-the-money-party). Accordingly, in some embodiments, if the close-out amount receiver is also the sole defaulting party, the junior investors 140 can be repaid the amount they respectively invested (i.e. when there has been a default by the parties to the derivatives, even the junior notes may, in certain circumstances, be fully secured by initial margin).

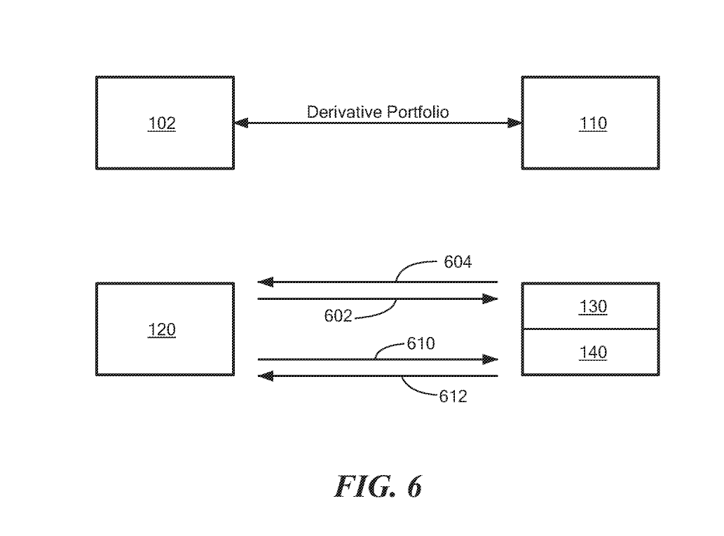

Now referring to FIG. 6, first and second parties 102, 110 can be parties to a derivative transaction and be required to post initial margins of particular amounts. AIMRA system 120 can generate IM Funding Amounts for first and second parties 102, 110 and generate notes for the IM Funding Amounts. As illustrated in FIG. 6, AIMRA system 120 can generate a senior note 602 having a first security level and a junior note 610 having a second security level. The senior note 602 can be provided to senior investors 130 and the junior note 610 can be provided to junior investors 140.

As stated above, at the time of the termination or default of the derivative transaction, even if both parties are defaulting parties, one party receives the entire amount of the initial margin they posted back as a returned initial margin amount and the same party may also receive a portion of the initial margin posted by the other party (e.g., if the other party owes the close-out amount and fails to pay). The value of the close-out amount is based on the close-out mark-to-market value of the derivatives at the time of the termination or default of the derivative transaction and takes into account the value of variation margin, if any, exchanged between the parties. Even a defaulting party that is out-of-the-money (i.e. a defaulting party that owes the close-out amount) can be entitled to the return of the initial margin they posted to the extent such amount is greater than the close-out amount owed by such party.

Thus, in one embodiment, the senior notes 602 can be backed by the either the first party 102 or second party 110 returned initial margin amounts at the time of the termination or default of the derivative transaction and the junior notes 610 may be partially backed by the returned initial margin minus the close-out amount of the party that owes the close-out amount (including, when applicable, a defaulting party). Stated differently, the senior investors 130 holding the senior notes 602 receive the first monies received (as determined by the AIMRA system 120) up to their respective loan amount upon termination or default of the derivative transaction and the junior investors 140 holding the junior notes 610 receive the remaining monies from the derivative transaction close-out amount owed by first party 102 or second party 110, as applicable, and the return of initial margin once the debts with the senior investors 130 have been settled in full.

Responsive to receiving the senior note 602, in some embodiments senior investors 130 can provide a senior loan 604 in an amount determined by AIMRA system 120 to the parties directly or via a special purpose vehicle or via another funding arrangement. In some embodiments, the value or amount of the senior loan 604 corresponds to the IM funding amount of at least one of first party 102 or second party 110. Responsive to receiving the junior note 610, in some embodiments junior investors 140 can provide a junior loan 612 in an amount determined by AIMRA system 120 to the parties directly or via a special purpose vehicle or via another funding arrangement. In some embodiments, the value or amount of the junior loan 612 corresponds to the IM funding amount of at least one of first party 102 or second party 110.

In some embodiments, if the initial margins posted by the first party 102 and/or second party 110 are government securities, the senior notes can be 100% backed by the respective government securities.

The senior notes 602 and junior notes 610 can be purchased by the same investor(s) or the senior notes 602 and junior notes 610 can be purchased by one or more different investors.

It should be appreciated that due to the collateral pledge from first and/or second parties 102, 110, and the Assured Initial Margin Return Amount and collateral package determined by AIMRA System 120, an aggregate interest paid on senior notes 602 and/or junior notes 604 can be reduced as compared with (a) notes generated without this collateral from the parties to the derivative transaction and (b) notes generated by first and/or second parties 102, 110, on an individual basis even with such collateral (since, when the parties are viewed individually, it is uncertain whether such collateral will be available to secure the notes of a particular party).

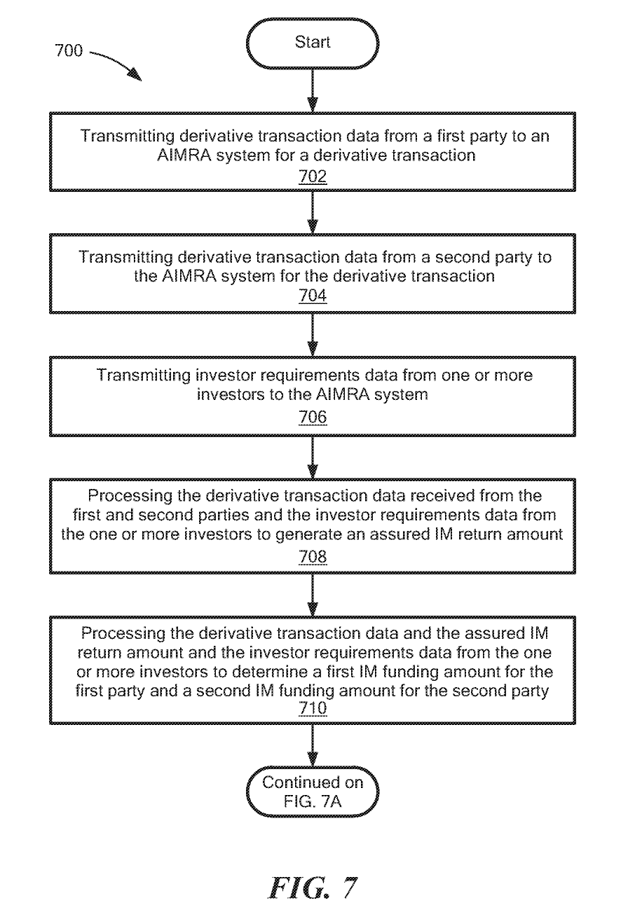

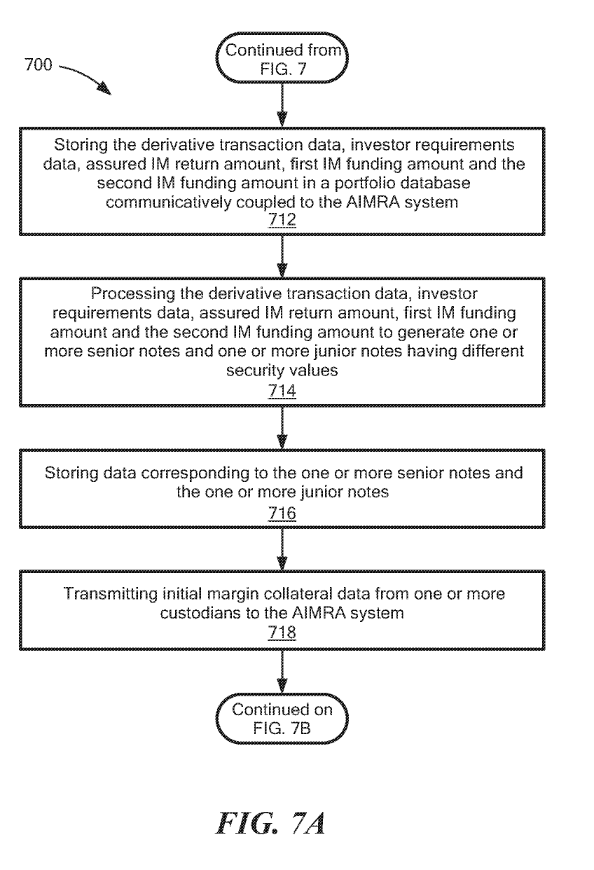

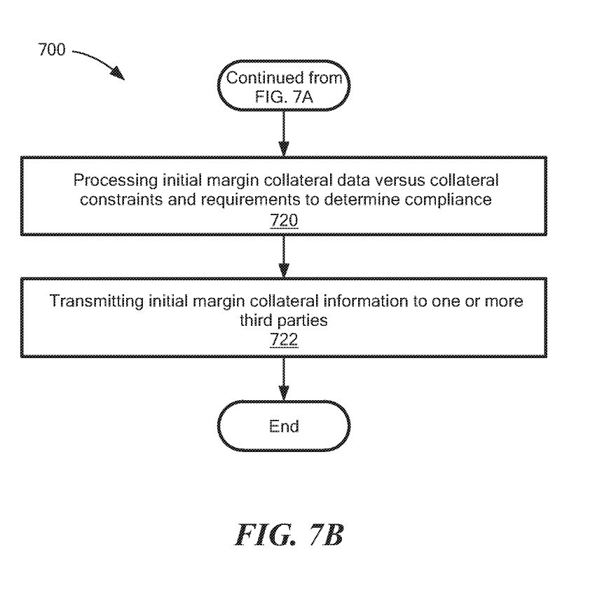

Now referring to FIGS. 7-7B, a method 700 begins at block 702, by transmitting derivative transaction data (e.g., initial margin data and/or derivative portfolio data) from a first party (e.g., first party 102 of FIG. 1) to a derivative transaction to an AIMRA system (e.g., AIMRA System 120 of FIGS. 1-1A). At block 704, derivative transaction data (e.g., initial margin data and/or derivative portfolio data) is transmitted from a second party (e.g., second party 110 of FIGS. 1-1A) to the derivative transaction to the AIMRA system (e.g., AIMRA system 120 of FIGS. 1-1A). (It should be noted that in some embodiments initial margin data and/or derivative portfolio data may be transmitted to the AIMRA System from the third party custodian(s) of first party and/or second party.) It should be appreciated that derivative transaction data as used herein may refer to derivative data, derivative portfolio data, initial margin data, funding requirements data and initial margin collateral parameters.

The AIMRA system can be remotely located from the first and second parties (or their custodians), therefore the AIMRA system can be communicatively coupled to the first and second parties (or their custodians) through a secure network, such as network 150 of FIG. 1. In an embodiment, the AIMRA system can securely retrieve and/or transmit data from one or more parties (or their custodians) to the derivative transaction.

The AIMRA system can encrypt the derivative transaction data, the initial margin data, and/or derivative portfolio data received from the first and second parties (or their custodians). For example, AIMRA system can include or be coupled to a portfolio database to store the derivative transaction data, the initial margin data and/or derivative portfolio data. The AIMRA system can store the encrypted data in the portfolio database. In one embodiment, the AIMRA system can establish an encrypted connection to each of the first and second parties (or their custodians).

In some embodiments, data corresponding to desired funding levels, tenor data, and/or collateral data (e.g., collateral constraints, collateral limits) can be transmitted by the first and/or second party (or their custodians) to the AIMRA system.

At block 706, investor requirements data can be transmitted to the AIMRA system from one or more investors. The investor requirements data may include requirements and/or preferences corresponding to the one or more investors that may potentially invest in the loans to the parties or the notes issued by an SPV or other funder, such as but not limited to investor amounts, tenor data and/or collateral requirements. The derivative transaction data, such as but not limited to, the initial margin data, portfolio data, desired funding data, investment amounts, tenor data, and collateral data can be stored in the AIMRA system.

At block 708, the AIMRA system can process the derivative transaction data from the first and second parties (or their custodians) to calculate an assured IM return amount. For example, the AIMRA system can analyze the initial margin data, portfolio data, desired funding data, investment amounts, tenor data, and collateral data to generate an assured IM return amount for the derivative transaction.

At block 710, the AIMRA system can process the derivative transaction data from the first and second parties (or their custodians) to calculate IM funding amounts applicable to the first and second parties, also referred to herein as a first IM funding amount for the first party and a second IM funding amount for the second party.

The assured IM return amount and/or the IM funding amounts can be based at least in part on the derivative transaction data received from the parties to the derivative transaction (or their custodians) or third parties, and/or the initial margins to be posted by the parties to the derivative transaction. For example, in one embodiment, the IM funding amount can be the lesser (or lower) of the initial margin amounts to be posted by the parties to the derivative transaction. The assured IM return amount and IM funding amounts can be encrypted by the AIMRA system and stored in the portfolio database.

The AIMRA system can determine an IM funding amount for each party to the derivative transaction. For example, in some embodiments, the IM funding amount can be the same for each party to the derivative transaction. In other embodiments, the AIMRA system can determine a different IM funding amount for each party to the derivative transaction.

In some embodiments, the AIMRA system can receive and process derivative transaction data, derivative portfolio data and initial margin data from the first and second parties (or their custodians) to determine the assured IM return amount for the derivative portfolio or a derivative transaction. The assured IM return amount can be a predetermined percentage of the initial margin posted by the first party or the second party. For example, in one embodiment, the assured IM return amount may be the lesser of the initial margins to be posted by either the first party or the second party.

Thus, notes to be issued to potential investors may be secured by the assured IM return amounts (which may be determined using the AIMRA system) based on the initial margins to be posted by the two parties to the derivative transaction. In an embodiment, investors (e.g., senior investors, junior investors) can use the assured IM return amount as security to reduce potential risk when funding the initial margins and, directly or indirectly (e.g., via an SPV) making loans to the first and second party to the derivative transaction.

At block 712, the AIMRA system can store the derivative transaction data, investor requirements data, assured IM return amount, IM funding amounts (e.g., first IM funding amount, second IM funding amount) in the portfolio database communicatively coupled to the AIMRA system. The derivative transaction data, investor requirements data, assured IM return amount, IM funding amounts (e.g., first IM funding amount, second IM funding amount) can be encrypted by the AIMRA system and stored in the portfolio database.

The AIMRA system can establish a combined account to compare and reconcile data received from the first and second parties (or their custodians) or any relevant third party in the portfolio database. The AIMRA system can use the separate accounts to store each party's respective initial margin data, derivative portfolio data and/or collateral data (e.g., initial margin collateral parameters).

At block 714, the AIMRA system can process the derivative transaction data, investor requirements data, assured IM return amount, first IM funding amount and the second IM funding amount to generate one or more senior notes and one or more junior notes having different security values. In an embodiment, total value of the one or more senior notes and the one or more junior notes corresponds to the total value of the first IM funding amount and the second IM funding amount.

The AIMRA system can process the derivative transaction data, investor requirements data, assured IM return amount, first IM funding amount and the second IM funding amount to determine various security packages that could be available to one or more class of investors. In one embodiment, the AIMRA system can determine issuance amounts (and underlying collateral) of one or more senior notes and one or more junior notes having different security values. The senior notes and/or junior notes can be used to fund the IM funding amounts to be provided to the parties of the derivative transaction in the form of counterparty loans. Thus, the values of the senior notes and/or junior notes can be based at least in part on the IM funding amounts and counterparty loans to be provided to the parties to the derivative transaction.

For example, in embodiments having two parties to the derivative transaction, AIMRA system can determine appropriate sizing for a first counterparty loan (from a special purpose vehicle or another funder) based on a first IM funding amount to the first party and a second counterparty loan (from a special purpose vehicle or another funder) based on a second IM funding amount to the second party. In some embodiments, the AIMRA system can determine appropriate sizing for senior notes having a total value corresponding to the assured IM return amount and the junior notes having a total value corresponding to the total IM funding amount less the assured IM return amount. Thus, in such an embodiment, a total value (or combined value) of the one or more senior notes and the one or more junior notes can correspond to the total IM funding amounts for all of the parties to the derivative transaction.

The AIMRA system can facilitate the counterparty loans (e.g., from a special purpose vehicle or another funder) through the secure network to the first and second parties based on their respective IM funding amounts. For example, in one embodiment, the AIMRA system can generate loan agreement data pertaining to the obligation of the first party to repay the first initial margin loan and loan agreement data pertaining to the obligation of the second party to repay the second initial margin loan.

In the loan agreements the obligation of the first and second parties to repay can include, and be secured by, a subordinated security interest in the return amounts, if any, of posted initial margin received back by the first party and/or the second party, as applicable, upon a termination or default of the derivative transaction. For example, the lenders can receive one or more liens or one or more pledges from the first party and/or the second party granting a subordinated security interest to the lender in all or a portion of the returned initial margin upon the termination or default of the derivative transaction. Thus, the AIMRA system can facilitate and process the provision of security (i.e. pledges of IM return amounts) to secure the initial margin loans received from lenders by the first party and/or the second party using one or more liens; the liens being subordinated to the interests of the swap parties themselves to the IM posted by the other party. In other words, the AIMRA system can facilitate and process the provision of security interests in the return of IM; such security interests being subordinated to the security interests of swap parties to whom the IM is pledged.

The AIMRA system can determine the amount of security available to secure one or more investments. The amount of security available can be based at least in part on the one or more liens received from the first and/or second party. For example, the AIMRA system factors in that at least one party to the derivative transaction will, in any and all circumstances, be entitled to receive back their entire posted initial margin upon a termination or default of the derivative portfolio (the AIMRA system can use this factor when calculating, determining, creating and generating the assured IM return amount). The other party may be entitled to receive all or a percentage of their posted initial margin minus a close-out value owed to the other party. Thus, the AIMRA system can calculate, determine, create and generate the assured IM return amount and determine security levels or guarantee portions of investments (e.g. senior and/or junior notes) based on the expected initial margin monies to be returned upon the termination or default of the derivative transaction(s).

In some embodiments, the senior notes can be fully secured by issuing a total amount of senior notes no greater than the assured IM return amount. In some embodiments, the total amount of the senior notes can equal the assured IM return amounts. In some embodiments, the total amount of the senior notes can be greater than the Assured IM Return Amounts. In some embodiments, the total amount of the senior notes can be less than the Assured IM Return Amounts.

In some embodiments, the total amount of the junior notes can be approximately equal to the assured IM return amount. In some embodiments, the total amount of the junior notes can be greater than the Assured IM Return Amounts. In some embodiments, the total amount of the junior notes can be less than the Assured IM Return Amounts.

Thus, in those embodiments where the total amount of the senior notes is less than or equal to the Assured IM Return Amount, a senior investor can invest in an instrument (e.g. a note or a loan) that is fully secured (e.g., 100% backed) by the assured IM return amount determined by the AIMRA system. The junior notes, although not fully secured, can still benefit from any initial margin remaining above the close-out amount due from the party that owes the close-out amount. Thus, even the junior investors can potentially lower their risk and the amount they charge for funding as well.

The issuance of senior and junior notes, with the senior notes effectively secured by the assured IM return amount, can be used by investors to, among other things, lower risk and/or the costs the investors charge for funding the initial margins for one or more parties to a derivative transaction. For example, the parties to the derivative portfolio can secure loans by providing pledges based on their potential returned initial margin amounts. Thus, an aggregate interest paid on senior notes and/or junior notes may be lower than notes issued without this collateral pledge from the parties to the derivative portfolio. The lowering of risk and/or costs can enable parties to the derivative portfolio to price uncleared derivatives more competitively.

At block 716, the AIMRA system can store the data corresponding to the one or more senior notes and the one or more junior notes. For example, in some embodiments, the AIMRA system can encrypt and store the one or more senior notes, the one or more junior notes, and/or other forms of investment data generated in connection with the derivative transaction in the portfolio database.

At block 718, one or more custodians can transmit initial margin collateral data to the AIMRA system. The one or more custodians may include third party custodians to hold the initial margins for the derivative transaction, a delegate of and/or any party responsible for holding the initial margins for the derivative transaction (or a delegate of said party).

At block 720, the AIMRA system can process the initial margin collateral data from the one or more custodians. The AIMRA system can be configured to determine compliance or non-compliance with collateral constraints and/or requirements for the derivative transaction. At block 722, the AIMRA system can transmit the initial margin collateral data to one or more third parties. In some embodiments, the initial margin collateral data may include data indicating compliance or non-compliance with collateral constraints and/or requirements for the derivative transaction. Method 700 may return to block 718, for example, in response to determining non-compliance and that the collateral constraints and/or requirements for the derivative transaction have not been met. For example, the AIMRA system may receive additional initial margin collateral data from the one or more custodians or from one or more different custodians. Method 700 may continue until the AIMRA system has determined the collateral constraints and/or requirements for the derivative transaction have been met.

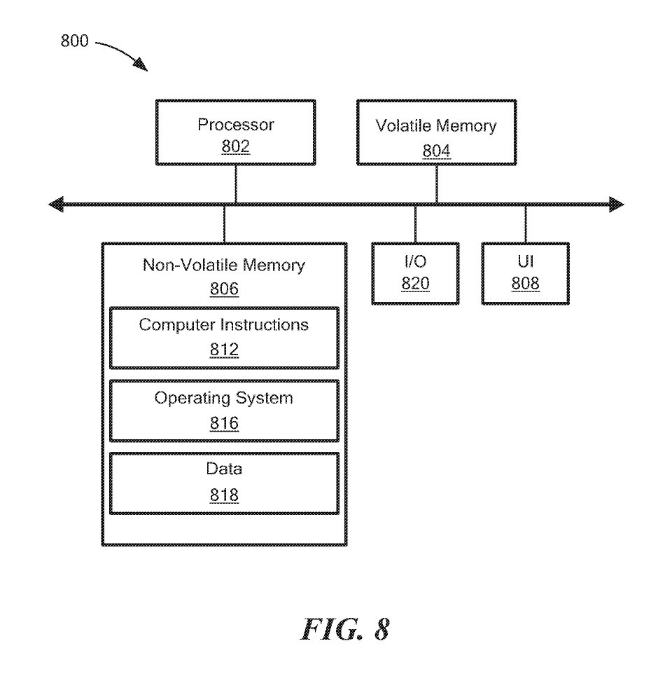

Referring to FIG. 8, in some embodiments, an AIMRA system (e.g., AIMRA system 120 of FIGS. 1-1A) may be implemented as one or more computers. Computer 800 may include processor 802, volatile memory 804 (e.g., RAM), non-volatile memory 806 (e.g., a hard disk drive, solid state drive such as a flash drive, a hybrid magnetic and solid state drive, etc.), graphical user interface (GUI) 808 (e.g., a display or touchscreen, etc.) and input/output (I/O) device 820 (e.g., a mouse, a keyboard, a touchscreen, and so forth). Non-volatile memory 806 stores computer instructions 812, an operating system 816 and data 818 such that, for example, the computer instructions 812 are executed by the processor 802 out of volatile memory 804 to perform at least a portion of method 700 of FIGS. 7-7B. Program code may be applied to data entered using an input device of GUI 808 or received from I/O device 820.

Method 700 is not limited to use with the hardware and software of FIG. 8 and may find applicability in any computing or processing environment and with any type of machine or set of machines that is capable of running a computer program. Method 700 of FIGS. 7-7B may be implemented in hardware, software, or a combination of the two.

The methods described herein are not limited to the specific embodiments described. For example, method 700 is not limited to the specific processing order shown in FIGS. 7-7B. Rather, any of the blocks of method 700 may be re-ordered, combined or removed, performed in parallel or in serial, as necessary, to achieve the results set forth herein.

Processor 802 may be implemented by one or more programmable processors executing one or more computer programs to perform the functions of the system. As used herein, the term “processor” is used to describe an electronic circuit that performs a function, an operation, or a sequence of operations. The function, operation, or sequence of operations can be hard coded into the electronic circuit or soft coded by way of instructions held in a memory device. A “processor” can perform the function, operation, or sequence of operations using digital values or using analog signals. In some embodiments, the “processor” can be embodied in an application specific integrated circuit (ASIC). In some embodiments, the “processor” can be embodied in a microprocessor with associated program memory. In some embodiments, the “processor” can be embodied in a discrete electronic circuit. The “processor” can be analog, digital or mixed-signal.

While illustrative embodiments have been described with respect to processes of circuits, described embodiments may be implemented as a single integrated circuit, a multi-chip module, a single card, or a multi-card circuit pack. Further, as would be apparent to one skilled in the art, various functions of circuit elements may also be implemented as processing blocks in a software program. Such software may be employed in, for example, a digital signal processor, micro-controller, or general purpose computer. Thus, described embodiments may be implemented in hardware, a combination of hardware and software, software, or software in execution by one or more processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid state memory, non-volatile memory, volatile memory, and so forth, but does not include a transitory signal per se. When embodied in a non-transitory machine-readable medium, and the program code is loaded into and executed by a machine, such as a computer, the machine becomes an apparatus for practicing the method.

When implemented on a processing device, the program code segments combine with the processor to provide a unique device that operates analogously to specific logic circuits. Such processing devices may include, for example, a general purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

What is claimed:

1. A method comprising:
transmitting derivative transaction data from a first party to an assured initial margin return amount (AIMRA) system for a derivative transaction;
transmitting derivative transaction data from a second party to the AIMRA system for the derivative transaction, wherein the AIMRA system is coupled to the first and second parties through an encrypted connection;
transmitting investor requirements data from one or more investors to the AIMRA system;
processing the derivative transaction data received from the first and second parties and the investor requirements data from the one or more investors to generate an assured IM return amount;
processing the derivative transaction data and the assured IM return amount and the investor requirements data from the one or more investors to determine a first IM funding amount for the first party and a second IM funding amount for the second party;
storing the derivative transaction data, investor requirements data, assured IM return amount, first IM funding amount and the second IM funding amount in a portfolio database communicatively coupled to the AIMRA system; and
processing the derivative transaction data, investor requirements data, assured IM return amount, first IM funding amount and the second IM funding amount to generate one or more senior notes and one or more junior notes having different security values, wherein a total value of the one or more senior notes and the one or more junior notes corresponds to the total value of the first IM funding amount and the second IM funding amount.

2. The method of claim 1, wherein derivative transaction data includes at least one or more of derivative data, derivative portfolio data, initial margin data, funding requirements data and initial margin collateral parameters.

3. The method of claim 1, further comprising receiving a first loan from a special purpose vehicle to fund the first IM funding amount and a second loan from the special purpose vehicle to fund the second IM funding amount.

4. The method of claim 3, further comprising issuing, by the special purpose vehicle, the senior notes and junior notes.

5. The method of claim 1, further comprising establishing an encrypted connection between the AIMRA system and the first and second parties, the one or more investors, or one or more third party custodians.

6. The method of claim 1, further comprising encrypting the derivative transaction data, investor requirements data, assured IM return amount, first IM funding amount and the second IM funding amount in the portfolio database.

7. The method of claim 4, further comprising issuing, by the special purpose vehicle, a first counterparty loan to the first party through the encrypted connection and a second counterparty loan to the second party through the encrypted connection.

8. The method of claim 1, further comprising assigning, by the AIMRA system, security values for the one or more senior notes and the one or more junior notes, wherein the one or more senior notes have a security value at a first level and the one or more junior notes have a security value at a second, different level.

9. The method of claim 1, wherein the total amount of senior notes is equal to a predetermined percentage of the first IM funding amount and the second IM funding amount.

10. The method of claim 1, wherein the total amount of the junior notes is equal to a predetermined percentage of the first IM funding amount and the second IM funding amount.

11. The method of claim 1, further comprising receiving, by the AIMRA system, segregated custodial account data for the first and second parties and storing the segregated custodial account data in the portfolio database.

12. The method of claim 1, wherein the senior notes are fully secured and the junior notes are partially secured.

13. The method of claim 1, wherein the AIMRA system is remotely located from the first and second parties.

14. A system comprising:
an assured initial margin return amount system (AIMRA) system;
a portfolio database communicatively coupled to the AIMRA system;
a first party coupled to the AIMRA system through a first secure connection, wherein the first party transmits derivative transaction data for a derivative transaction to the AIMRA system;
a second party coupled to the AIMRA system through a second secure connection, wherein the second party transmits derivative transaction data for the derivative transaction to the AIMRA system;
wherein the AIMRA system is configured to:
process the derivative transaction data from the first and second parties to generate an assured IM return amount, a first IM funding amount for the first party, a second IM funding amount for the second party;
store the derivative transaction data, the assured IM return amount, the first IM funding amount, the second IM funding amount in the portfolio database; and
process the derivative transaction data, the assured IM return amount, the first IM funding amount, the second IM funding amount to generate one or more senior notes and one or more junior notes having different security values, wherein a total value of the one or more senior notes and the one or more junior notes corresponds to the total value of the first IM funding amount and the second IM funding amount.

15. The system of claim 14, wherein the first and second secure connections form a secure network between the AIMRA system and the first and second parties.

16. The system of claim 14, wherein the AIMRA system is configured to encrypt the derivative transaction data, the assured IM return amount, the first IM funding amount, the second IM funding amount, the one or more senior notes, and the one or more junior notes in the portfolio database.

17. The system of claim 14, wherein the AIMRA system is configured to process the derivative transaction data, the assured IM return amount, the first IM funding amount, the second IM funding amount to generate a first counterparty loan for the first party and generate a second counterparty loan for the second party.

18. The system of claim 14, wherein the AIMRA system is communicatively coupled to segregated custodial accounts for the first and second parties and stores segregated custodial account data for the first and second parties in the portfolio database.

19. The system of claim 14, wherein the AIMRA system is remotely located from the first and second parties.

20. A method for securing and collateralizing funding between multiple parties based on initial margin values of the parties, the method comprising:
determining and generating, by an assured initial margin return amount system (AIMRA) System, an assured IM return amount;
determining, by the AIMRA system, a first IM funding amount for a first party to the derivative transaction;
determining, by the AIMRA system, a second IM funding amount for a second party to the derivative transaction;
generating, by the AIMRA system, first and second counterparty loans for the first and second parties, respectively, wherein the first and second counterparty loans are a predetermined percentage of the first and second IM funding amounts;
establishing, by the AIMRA system, one or more senior notes and one or more junior notes having different security values, wherein a total value of the one or more senior notes and the one or more junior notes corresponds to the total value of first and second IM funding amounts; and
securing and collateralizing, by the AIMRA system, the first and second counterparty loans to the first and second parties, respectively through initial margin posted by the first and second parties, respectively, for the derivative transaction.
